(19) United States
(12) Patent Application Publication
(10) Pub. No.: US 2002/0089989 A1
(43) Pub. Date: Jul. 11, 2002

(54) Method and system for analysing a data packet or frame

(76) Inventors: Morten Jagd Christensen, Copenhagen (DK); Martin Elhoj, Malmo (SE)

Correspondence Address: HARNESS, DICKEY & PIERCE, P.L.C., P.O. Box 8910, Reston, VA, 20195, US

(21) Appl. No.: 09/965,078

(22) Filed: Sep. 28, 2001

Related U.S. Application Data
(60) Provisional application No. 60/237,524, filed on Oct. 4, 2000.
(60) Provisional application No. 60/284,868, filed on Apr. 20, 2001.

(51) Int. Cl. H04L 12/56

(52) U.S. Cl. 370/395.42; 370/409

(57) ABSTRACT

A method of categorizing a data packet or frame, such as an Ethernet packet or a Sonet frame, where one or more features of the packet or frame are identified and a corresponding priority assigned. At least two priorities, a higher and a lower priority, are used. If none of the sought after features are identified, such as if the packet or frame is of an unknown type, the packet or frame is assigned the higher priority.

The present invention relates to a method and a system for analysing a data packet or frame. This analysis results in the packet or frame being assigned a priority relating to one or more features thereof.

The assigning of a priority to a data packet or frame is a manner of providing Quality of Service or Differentiated Services in data networks or on data links. A high priority data packet or frame may at certain positions in the network or links overtake data packets or frames having a lower priority. In this manner, and especially when congestion occurs, certain, e.g. types of, data packets or frames will still be able to flow through the network or link. This is important when the packets or frames relate to e.g. a real time process, such as Voice over IP or streaming video. The quality of the product (audio or video) will be lowered if large delays take place in the data transfer or if large variations are experienced in the delay.

A number of manners exist of analysing a data packet or frame and assigning a priority. One of the problems encountered is that a large number of different packet/frame types or constellations exist—and that most of these today relate to non-real time processes. Thus, a large amount of processor power may be used for analysing a packet/frame, which, as it turns out, is a low priority packet/frame.

The present invention relates to a rather simple manner of analysing a packet/frame, and in a first aspect, the invention relates to a method of categorising a data packet or frame, the method comprising:

providing a plurality of priority levels having at least a higher priority level and a lower priority level,

providing a number of data packet or frame features, each feature being correlated to one of the priority levels,

analysing one or more parts of the data packet or frame in order to identify one or more of the features,

if a feature is identified, the packet or frame is assigned the priority of that feature, if not, the data packet or frame is assigned the higher priority level.

In the present context, a feature may be any information derivable from the packet or frame. The simplest feature will be that of a predefined bit being set or not. A more complex feature is whether the packet or frame conforms to a given standard or whether a field of a given type is present or not. Also, a combination of features may be identified, such as that the packet or frame e.g. conforms to a given standard, is tagged, and that a priority of the tag header is above, equal to or below a given value.

The step of providing the features and corresponding priority level(s) will normally simply be one of defining these. However, this definition needs not be fixed. Changes may be desired in order to adapt the categorising/prioritising to a change in data flow/contents.

In this context, the assigning of a priority may be the adding to the data packet or frame of information relating to the priority—or simply a differentiated handling of the data packets or frames in accordance with the priority thereof.

A priority level may be any indication of the “importance” of the packet. Normally, a priority level will be an integer between 1 and 64, such as between 1 and 8. However, any other manner may be used for indicating the priority level as long as it is determinable which of two different priorities is the highest (this could be predefined). In fact, the priority levels may also be intervals of individual priorities, such as a priority interval of 4-6.

The assigning step may be a single step where it is determined whether any of the features were identified in the packet or frame and where, in that situation, the pertaining priority level is assigned. If no feature is identified, the higher priority level is assigned. Optionally, the step may be divided so that the packet or frame is initially assigned the higher priority level, which may subsequently be overwritten by a lower priority level of a feature identified in the packet or frame.

A data packet or frame may be any collection of data. The packet or frame may conform to any communication standard—or not. If the packet or frame conforms to a standard, individual parts thereof—fields according to the standard—will be defined by the standard. Other parts may be individual bits or bytes. Normally, a packet or frame will have a data part and a link/networking/routing part having information for use in the transporting of the data part from a transmitter to a receiver. In that situation, usually all parts used for the categorisation are found in the link/networking/routing part.

In the preferred embodiment, a feature may be that the packet or frame conforms to one or more from the group consisting of: IEEE 802.2, Ethernet II, LLC+SNAP, VLAN-tagged Ethernet I, VLAN-tagged IEEE 802.2, and VLAN-tagged LLC+SNAP.

In general, a feature could be whether the data packet or frame stems from a real time application, such as Voice over IP, streaming video, streaming audio, video conferencing, or IP telephony. In this situation, a higher priority may be assigned due to the importance of providing the data in time to the receiver in order to maintain a high quality in the audio/video.

Also, a feature could be whether the data packet stems from an application from the group consisting of: FTP, telnet, SMTP, WWW, DNS, Netbios, and NFS. Such procedures are normally non-real time procedures, which means that a lower priority may be assigned in order to cater for the real-time procedures on the same network.

In the preferred embodiment:

the step of providing the features comprises providing a priority level to one or more combinations of features,

the analysing step comprises identifying one of the combinations of features in the data packet or frame, and

the assigning step comprises assigning the priority relating to the combination identified.

A combination of features means that all of the features of the combination must be present, such as that the packet or frame conforms to a given standard, is tagged, and that a predetermined bit is set.

A number of the established standards already specify different types of priorities or traffic classes, such as the Differentiated Services code point found in IPv4 packets or frames. It may be desired to utilise this information, and a feature may be a Differentiated Service code point above a predetermined value, and wherein the corresponding priority is a first priority level, preferably the higher priority level—and a feature could equally be a Differentiated Services code point below a predetermined value, and wherein the corresponding priority is a second priority level, preferably the lower priority level. Naturally, the actual DS code point could be used, if the number of possible DS code points does not exceed the number of priority levels used in the present method.

In order to keep the present method simple, preferably 8 or less priority levels are provided, such as 4 or less, such as two priority levels may be provided.

In the preferred embodiment, unknown packets or frames (being unknown in the sense that they have none of the features looked for) are given the highest possible priority. In that situation, the higher priority level is the highest priority level of the plurality of priority levels.

The above method gives a fast and normally rather coarse categorisation of the packet or frame. However, it provides a programmability in that it may, on the fly, be determined that in the future, another feature should be looked for—or that the priority assigned to a given feature or combination of features is altered. In this manner, the categorisation may be adapted to changes in the data flow of the link or network using the present method.

Naturally, more than a single feature may be identified, whereby the analyser will have to choose between multiple, possibly different, priorities. Any solution to this situation may be used. One manner is to prioritise the features and stop looking for more when one has been identified (so that only a single feature is, in fact, identified and only one priority determined). Another manner is to always take the highest priority of the features identified.

In another aspect, the invention relates to a device for categorising a data packet or frame, the device comprising:

means for providing the data packet or frame,

means for analysing one or more parts of the data packet or frame in order to identify one or more of a number of predetermined data packet or frame features, each feature being correlated to a priority level of a plurality of priority levels having at least a higher priority level and a lower priority level,

means for assigning the data packet or frame a priority level, the priority level assigned being that relating to one or more features identified or the higher priority level, if no features are identified.

The providing means may actually generate or simply receive the packet or frame.

The analysing means may derive/copy the parts from the packet or frame or may simply determine whether the features are present therein. For some features, the identification may be rather simple and for others, a number of different fields and their relative position may need to be identified in order to determine whether a feature is present.

The assigning means may comprise storage, such as a look-up-table, for holding the individual priority levels corresponding to the individual features and combination(s) of features.

In one embodiment, the analysing means are adapted to identify whether the packet or frame conforms to one or more from the group consisting of: IEEE 802.2, Ethernet II, LLC+SNAP, VLAN-tagged Ethernet II, VLAN-tagged IEEE 802.2, and VLAN-tagged LLC+SNAP.

Preferably, the analysing means are adapted to identify a feature relating to whether the data packet or frame stems (or not) from a real time application, such as Voice over IP, streaming audio, video conferencing, IP telephony, or streaming video.

Also, the analysing means could be adapted to identify a feature relating to whether the data packet stems from an application from the group consisting of: FTP, telnet, SMTP, WWW, DNS, Netbios, and NFS.

It is preferred that the analysing means are adapted to identify one or more combinations of features, each combination corresponding to a priority level, and wherein the assigning means are adapted to assign the priority level corresponding to an identified combination of features. This gives a more versatile categorisation of the packets or frames.

As mentioned above, the analysing means could be adapted to identify a feature being a Differentiated Service code point above a predetermined value, and wherein the corresponding priority level is a first priority, preferably the higher priority level—and/or the analysing means could be adapted to identify a feature being a Differentiated Service code point below a predetermined value, and wherein the corresponding priority level is a second priority, preferably the lower priority level. Naturally, the actual DS code point could also be used as a measure of the priority to assign.

For simplicity, the assigning means are preferably adapted to assign one of 8 or less priority levels, such as one of 4 or less, such as one of two priority levels.

As mentioned above, it is preferred that the higher priority level is the highest priority level of the plurality of priority levels.

Programmability is obtained when the device further comprises means for altering, adding or deleting a feature or a combination of features or one or more corresponding priority level(s).

In a third aspect, the invention relates to a system for transporting a data packet or frame between an input port and an output port, the system comprising:

a device as described above,

a plurality of queues each corresponding to one or more of the plurality of priority levels,

means for providing the data packet or frame to a queue corresponding to the priority level assigned by the device, and

means for outputting data packets or frames from the queues to the output port.

Thus, in this aspect, the packets or frames are put into queues as a result of the category/priority assigned. The outputting may be performed in accordance with the priorities assigned so that if any data packets or frames are present in a highest priority queue, these data packets or frames are output first. If not, data in a non-empty highest priority queue are identified and output. In this manner, higher priority data may overtake lower priority data in this system.

The present system may be any networking component, such as a switch, a router, a hub, a repeater—or just a part thereof.

In general, the present invention provides compatibility with future protocols utilised on network communications, since the method ensures that unknown data packet types are given high priority. Also, the method/device/system may be altered to have one or more features of the former unknown data packets or frames entered together with corresponding priority/ies in order to then be registered as a known type. Additionally, the method accomplishes a good analysis relative to the state of the art, since as long as classification of known types of data packets covers most of the data traffic, sufficient traffic will be given low priority to ensure that high priority traffic can be forwarded quickly and only experience a minimum of delay.

In the following, the preferred embodiment will be described with reference to the drawings.

### BRIEF DESCRIPTION OF THE DRAWINGS

FIG. 1 illustrates three different Ethernet frame encapsulations with and without VLAN tagging.

FIG. 2 illustrates a priority state diagram for a mixture of fixed parameters and configurable parameters.

FIG. 3 illustrates a byte stream.

FIG. 4 illustrates a system using a categorizing device.

### DETAILED DESCRIPTION OF THE DRAWING

The purpose of the presently preferred categorizer scheme is to offer support for real-time traffic, such as video or voice, on the network. This is a very simple, yet configurable, scheme, which basically is taking the opposite approach to traditional QoS.

“You can spend 90% of the time trying to identify the 20% real-time traffic or spend 10% identifying the 80% non real-time traffic.”—We chose the latter.

Every frame can have two priorities (High or Low) and is initially considered to have a high priority until categorizing determines otherwise. We assign low priorities to protocols that we know are not carrying real-time traffic, i.e. FTP, telnet, SMTP, WWW, DNS, Netbios, NFS, etc. An alternative would be to have these known protocols have one of a number of priorities.

We know from Internet traffic measurement reports that this will cater for about 68% of the traffic. For intranet traffic based on networked Windows workstations combined with Unix file servers, similar numbers apply.

Frame types

There exist three different Ethernet protocol encapsulations. These are

Ethernet II

802.3/802.2

802.3/802.2SNAP

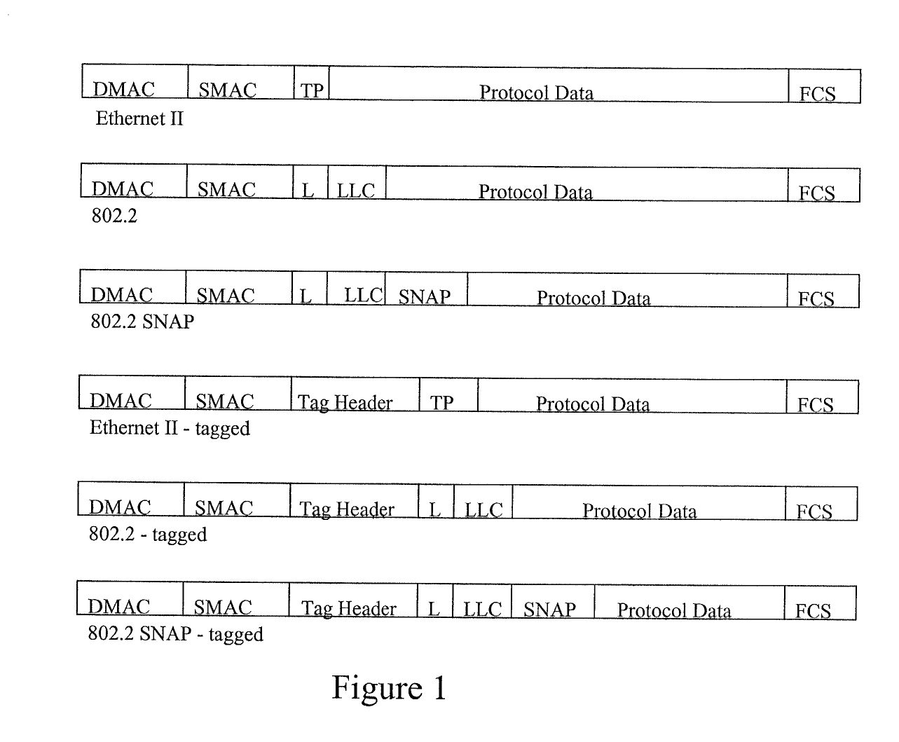

These are all shown in FIG. 1. In the following, we will describe all three (six) in detail.

Ethernet II

This is the de-facto standard for most LAN traffic: All Windows®, Linux and most other Unix® machines produce frames with this encapsulation. Ethernet II can be recognized by the type field following the SMAC field. If the type is larger than 0×600 then it is an Ethernet II frame.

802.3/802.2

This is an 802.3 frame with 802.2 (LLC) encapsulation. LLC frames have a TP field smaller than 0×600 and a DSAP (first byte of the LLC header) belonging to assigned values. ISO assigns and maintains the DSAP values. Currently there is only one value to be recognized here: 0×E0 (Novell)

802.31802.2SNAP (LLC/SNAP)

This is an 802.3 frame with LLC+SNAP encapsulation. The frame must have a TP field smaller than 0×600 and an LLC field of {0×AA, 0×AA, 0×03} (network byte order)

The SNAP header identifies the higher layer protocols. Known values are for example:

{0×00, 0×00, 0×00, 0×08, 0×00}IP

{0×00, 0×00, 0×00, 0×80, 0×35}RARP

{0×00, 0×00, 0×00, XX, YY}XXYY is an ethertype as in Ethernet II

FIG. 1 illustrates the three different Ethernet frame encapsulations.

Tagged frames

FIG. 1 also illustrates the three frames tagged, in which case a four-byte field is inserted after the SMAC field and prior to the type/length field. The first two bytes must match the pattern 0×8100. Tagged frames carry a priority field, which can be used to priority assignment. See 802.1Q 1998 Table 8.2.

The categorizer state machine

The categorizer has two tasks

1) identify the frame types including the position in the data stream of the relevant data.

2) assign priorities based on certain matches.

Priorities

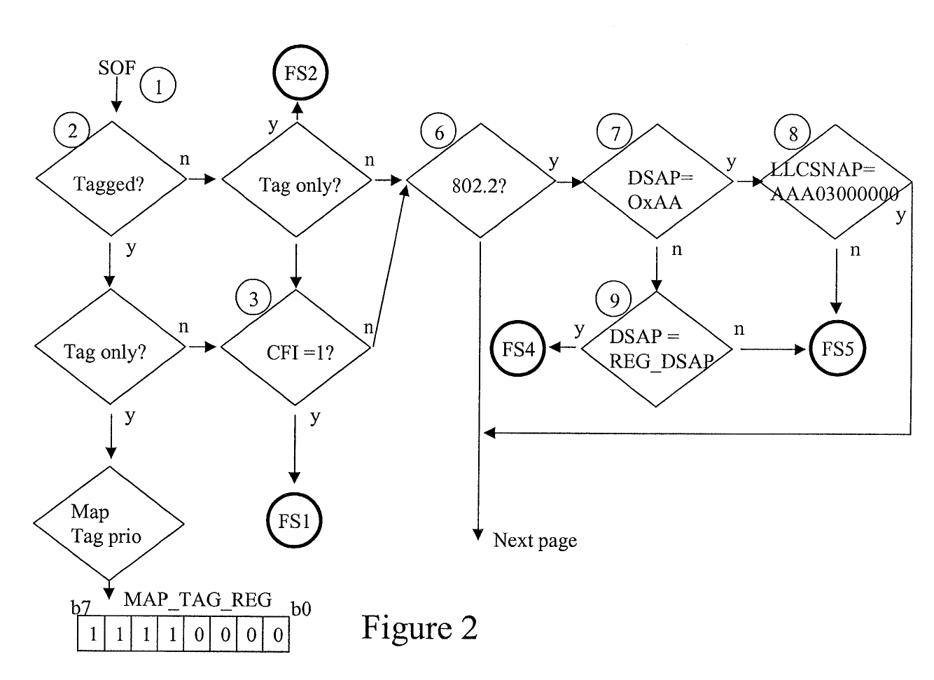

A reasonable flexibility is obtained by implementing the state diagram shown in FIG. 2. There exist a number of final states. These states are reached by moving through the state diagram and comparing fields of the frame with fixed or configurable parameters.

Three different types of end states are recognized:

1) VLAN based user priority end states (8 states). These are shown in FIG. 2 as MAP_TAG_REG.

2) DS (Differentiated Services) end states, where a direct masking of the 64 DS Code Points is used.

3) Frame parsing and pattern matching end states (7 states). These are the FSx states shown in FIG. 2.

FIG. 2 illustrates a priority state diagram for a mixture of fixed parameters and configurable parameters.

Configurable variables/registers may be seen from Table 1.

Identification of fields and frame types

In the following, the individual states of the state diagram will be discussed. Common to these is that one or more octets of the data stream must match certain patterns. The convention for referencing bytes of the data stream is [X,Y, . . . ]=“pattern”.

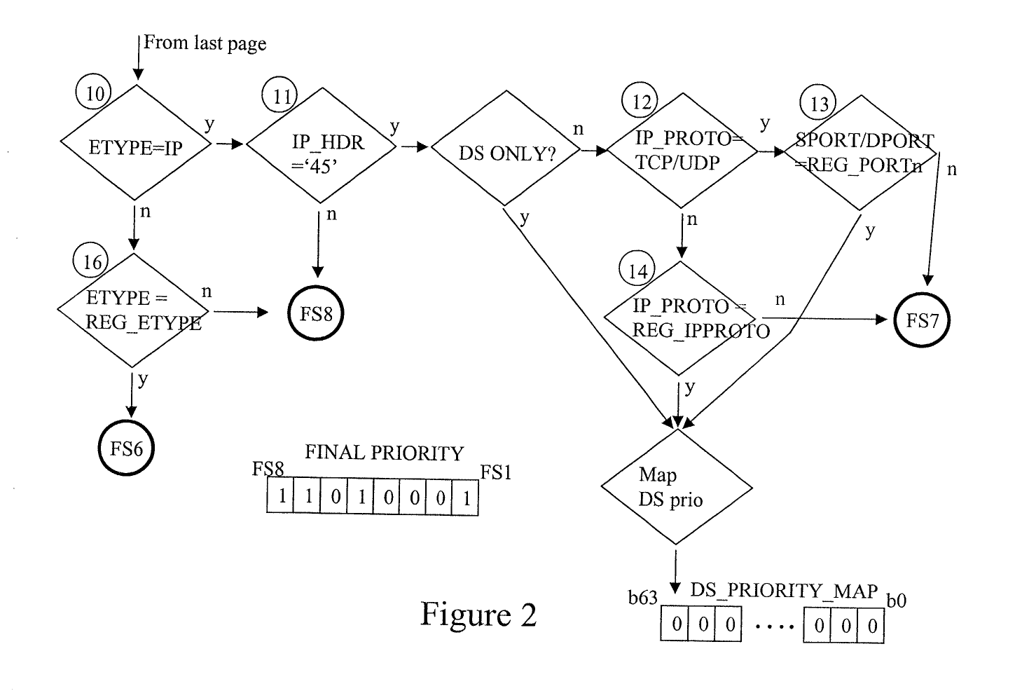

FIG. 3 illustrates the byte stream. The first byte of the DMAC address starts at offset 0.

For example [12,13]=0×800 means that byte 12 and 13 of the frame data (the TL field in the above figure) match the value 0×0800 (network byte order) and OF[12,13]=0×0800 means that byte 12+OF and bytes 13+OF match the value 0×0800.

In table 2, the state# column refers to the numbers in FIG. 2.

The state diagram of FIG. 2 starts in state 1 determining whether a Start Of Frame has been found. If so, it is determined (in state 2) whether the frame is tagged. The two shaded “tag only?” processes enquire whether the categorizer is to categorize the frame on the basis of only a tag.

If state 2 determines that the “tag only?” is “yes”, the tag priority (3 bits—8 different possibilities) of the frame is mapped onto the priorities (two—a high and a low) of the Categorizer. The vector simply specifies that priorities 4-7 have a high priority (1) and 0-3 a low (0).

If the frame is tagged and the categorizing is not to be based on the tag alone, state 3 checks whether the CFI bit it set. If so, a specific priority is chosen (end state FS1). The priorities relating to each of the 8 end states are defined in the FINAL PRIORITY vector specifying for FS1 a low priority (0).

If the frame is not tagged, and if the categorization is “tag only”, end state FS2 is reached—and the priority chosen from the FINAL PRIORITY vector is low (0).

If the CFI bit was not set—or if the frame was not tagged and the categorization is not “tag only”, state 6 is reached wherein it is checked whether the frame conforms to IEEE 802.2. If so (that means that there is a length value in the T/L field), the DSAP value is checked (identity to 0×AA)—state 7. If so, the SNAP value is checked as to identity to AAA03000000—state 8. If so, a type value is present and state 10 performs the further analysis. If state 7 provides a “no”, state 9 is reached where the identity of the DSAP field to a programmable REG_DSAP field is check. Identity provides an end state FS4 and non-identity the end state FS5. FS5 can also be reached by the state 8 giving a “no”.

The programmable REG_DSAP provides flexibility into the system in that both the priorities of FS4 and FS5 as well as the register may be set by an operator. Different values will give different priorities and thereby different functionalities of the system.

If state 10 is reached, a type field is present. It is then checked whether the type of the frame is IP. If not, the ETYPE is compared to a programmable REG_ETYPE and the result will be FS6 or FS8. Again, different values of the REG_ETYPE will give different functionalities—as well as different priorities of FS6 and FS8.

If the type is IP (state 10), the header of the IP packet is checked for the value “45” which means that the frame is an IPv4 frame with a header of length 20.

If the value is not “45”, FS8 is reached. The checking of the header length 20 is merely for simplicity of the following analysis (identification and analysis of subsequent fields). Thus, a more versatile version would be made if only IPv4 is identified—irrespective of the header length.

If state 11 gives a “yes”, the categorizer checks whether it runs in a “DS only” mode wherein it only prioritises these frames on the basis of a DS. If so, the DS code points (64 different values mapped into 8 or 64 priority levels) is mapped onto the priorities of the categorizer (1 or 0). As is the case with the MAP_TAG_REG, the DS_PRIORITY_MAP is a vector comprising “0”'s where the priority is low and “1”'s where it is high.

If the mode is not “DS only”, it is checked whether the frame is a TCP or UDP frame. If so, the port number is compared to a programmable REG_PORTn, and if so, the DS code point is chosen (mapped to the categorizer priorities). If not, FS7 is reached. Again, the programmability of REG_PORTn provides versatility.

If the frame was not a TCP or UDP frame (state 12), the type identified is compared to a programmable type REG_IPPROTO—and if this is the type, FS7 is reached. If not, the mapped DS code point is used.

In general, frames, the type of which are known, will receive priorities defined either by FS2, MAP_TAG_REG or DS_PRIORITY_MAP. Frames having specific predefined, programmable types/features will end up in FS4, and FS6. FS1, FS5, FS7, and FS8 collect frames not having a well-defined type or feature. Therefore, the priorities of these four end states give the frame a high priority according to the invention. Naturally, other features or types of frames may have a high priority. In the present categorizer, some of the priorities of tagged frames or DS frames are given the high priority.

Thus, a simple frame analysis is provided with a wide variety of possible end states and a wide variety of programmable states or types with which the frame is compared. Thus, a fast and simple analysis easily programmable or adapted is provided in that the REG . . . and the FS . . . may be altered to take changing traffic flow patterns into account—or to take new frame types into account. Below, different applications of this categorizer are discussed.

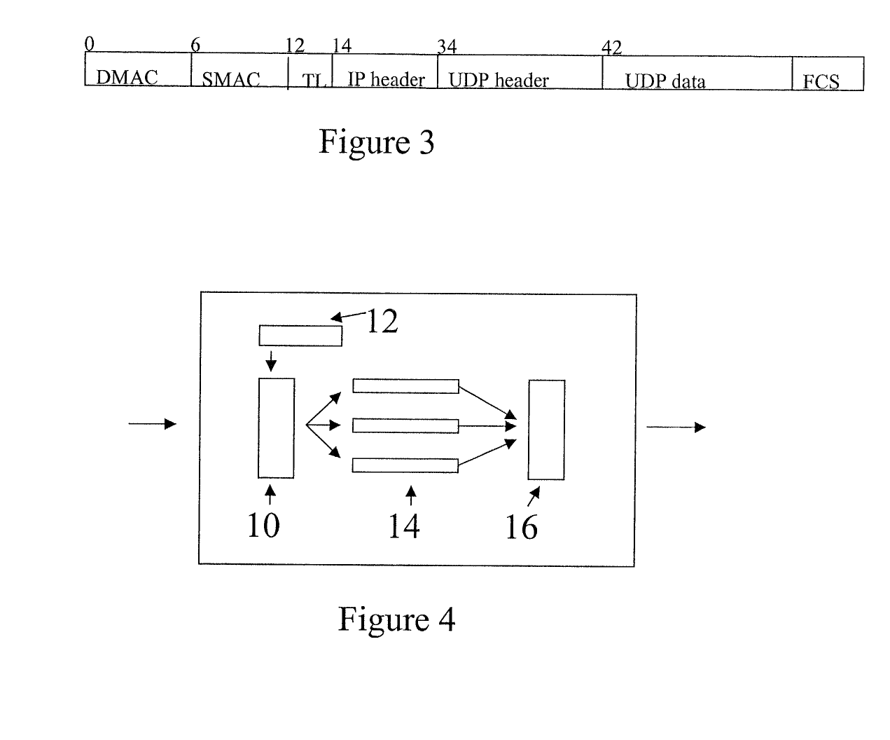

FIG. 4 illustrates a data packet or frame handling system, such as a part of a switch, hub, or router, where a data packet or frame enters via an input port into a categorizing device 10 which categorizes the data packet or frame using feature and priority data stored in a storage 12 and then feeds the packet or frame to one of buffers 14 corresponding to the priority assigned. Subsequently, means 16 are used for deriving data frames or packets from the buffers 14 and output these on an output port. Preferably, the means 16 will derive packets from the higher priority buffer(s) and only from lower priority buffer(s) if no data are present in the higher priority buffer(s).

This system may form part of a switch or the like and be present at all input ports thereof in order to ensure that Head Of Line blocking does not take place.

### Applications

The main application (and flexibility) for the present categorizer is for TCP/IP based network environments. This is by far the most common case today.

The categorizer can be operated in a DS-only mode where the only information used for assigning priorities is the DS field. This is not recommended yet but may be the preferred case in the future as DS gains momentum.

For a very specialized TCP/IP based network (for example heavy use of X windows or Network backup) all 10 TCP/UDP ports can be configured in order to provide sufficient QoS for real-time applications.

If a new “killer application” becomes dominant or if for example one of the security protocols are heavily used the IP_PROTO register can be configured to match the requirement.

If there is considerable IPX traffic in the network the ETYPE register should be configured to 0×8137, which will allow for IPX to be assigned a low priority.

For VLAN based networks the categorizer can be operated in TAG-only mode in which case only the user priority field of the TCI field is used for priority assignment.

Finally, if OSI or other protocols using the LLC encapsulation requires a special DSAP, but does not carry real-time traffic, the DSAP register can be configured.

1. A method of categorising a data packet or frame, the method comprising:
providing a plurality of priority levels having at least a higher priority level and a lower priority level,
providing a number of data packet or frame features, each feature being correlated to one of the priority levels,
analysing one or more parts of the data packet or frame in order to identify one or more of the features,
if a feature is identified, the packet or frame is assigned the priority of that feature, if not, the data packet or frame is assigned the higher priority level.

2. A method according to claim 1, wherein the features comprise whether the packet or frame conforms to one or more from the group consisting of: IEEE 802.2, Ethernet II, LLC+SNAP, VLAN-tagged Ethernet II, VLAN-tagged IEEE 802.2, and VLAN-tagged LLC+SNAP.

3. A method according to claim 1, wherein a feature is whether the data packet or frame stems from a real time application.

4. A method according to claim 1, wherein a feature is whether the data packet stems from an application from the group consisting of: FTP, telnet, SMTP, WWW, DNS, Netbios, and NFS.

5. A method according to claim 1, wherein:
the step of providing the features comprises providing a priority level to one or more combinations of features,
the analysing step comprises identifying one of the combinations of features in the data packet or frame, and
the assigning step comprises assigning the priority relating to the combination identified.

6. A method according to claim 1, wherein a feature is a Differentiated Service code point above a predetermined value, and wherein the corresponding priority is a first priority level, preferably the higher priority level.

7. A method according to claim 1, wherein a feature is a Differentiated Service code point below a predetermined value, and wherein the corresponding priority is a second priority level, preferably the lower priority level.

8. A method according to claim 1, wherein 8 or less priority levels are provided, such as 4 or less, such as two priority levels are provided.

9. A method according to claim 1, wherein the higher priority level is a highest priority level of the plurality of priority levels.

10. A method according to claim 1, wherein a feature or a combination of features or a corresponding priority level is/are altered.

11. A device for categorising a data packet or frame, the device comprising:
means for providing the data packet or frame,
means for analysing one or more parts of the data packet or frame in order to identify one or more of a number of predetermined data packet or frame features, each feature being correlated to a priority level of a plurality of priority levels having at least a higher priority level and a lower priority level,
means for assigning the data packet or frame a priority level, the priority level assigned being that relating to one or more features identified or the higher priority level, if no features are identified.

12. A device according to claim 11, wherein the analysing means are adapted to identify a feature relating to whether the packet or frame conforms to one or more from the group consisting of: IEEE 802.2, Ethernet II, LLC+SNAP, VLAN-tagged Ethernet II, VLAN-tagged IEEE 802.2, and VLAN-tagged LLC+SNAP.

13. A device according to claim 11, wherein the analysing means are adapted to identify a feature being whether the data packet or frame stems from a real time application.

14. A device according to claim 11, wherein the analysing means are adapted to identify a feature relating to whether the data packet stems from an application from the group consisting of: FTP, telnet, SMTP, WWW, DNS, Netbios, and NFS.

15. A device according to claim 11, wherein the analysing means are adapted to identify one or more combinations of features, each combination corresponding to a priority level, and wherein the assigning means are adapted to assign the priority level corresponding to an identified combination of features.

16. A device according to claim 11, wherein the analysing means are adapted to identify a feature being a Differentiated Service code point above a predetermined value, and wherein the corresponding priority is a first priority level, preferably the higher priority level.

17. A device according to claim 11, wherein the analysing means are adapted to identify a feature being a Differentiated Service code point below a predetermined value, and wherein the corresponding priority is a second priority level, preferably the lower priority level.

18. A device according to claim 11, wherein the assigning means are adapted to assign one of 8 or less priority levels, such as 4 or less, such as two priority levels.

19. A device according to claim 11, wherein the higher priority level is a highest priority level of the plurality of priority levels.

20. A device according to claim 11, further comprising means for altering a feature or a combination of features or one or more corresponding priority level(s).

21. A system for transporting a data packet or frame between an input port and an output port, the system comprising:
a device according to claim 11,
a plurality of queues each corresponding to one or more of the plurality of priority levels,
means for providing the data packet or frame to a queue corresponding to the priority level assigned by the device, and
means for deriving data packets from the queues to the output port
TABLE 1

| Register name | Suggested Value |
|---|---|
| ETYPE | 0×0800 |
| DSAP | 0×AA |
| IP_PROTO | 0×06 |
| IP_PORTn¹ | 80, 20, 2049, 119, 139 + 5 unused ports |
| FINAL_PRIORITY | 0×8B |
| MAP_TAG_REG | 0×F0 |
| DS_PRIORITY | 0×FE |
| DS_PRIORITY_MAP | 0×0000 0000 0000 0000 |
| Bits per port | n/a |
| Bits in total | n/a |

¹REG_PORT1 through REG_PORT10
TABLE 2

| State | | |
|---|---|---|
| # | Positive ID | Action after positive ID |
| 1 | Start of frame | OF=0 |
| 2 | [12, 13] = 0×8100 | OF+=4 |
| 3 | [14] &0×10 | |
| 5 | ([14] & 0×E0) special handling of this | |
| 6 | OF[12, 13] < 0×0600 | |
| 7 | OF[14]=0×AA | |
| 8 | OF[14,..19]= | OF+=8 |
| | 0×AAAA03000000 | |
| 9 | OF[14]= REG_DSAP | |
| 10 | OF[12, 13] = 0×0800 | |
| 11 | OF[14] =0×45 | |
| 12 | OF[23]=17 OR | |
| | OF[23]=6 | |
| 13 | OF[34, 35] = REG_PORT1 OR | |
| | OF[36, 37] = REG_PORT1 | |
| | OR | |
| | OF[34, 35] = REG_PORT2 OR | |
| | OF[36, 37] = REG_PORT2 | |
| | OR ... up to reg_port10 | |
| 14 | OF[23] = REG_IPPROTO | |
| 16 | OF[12, 13]= REG_ETYPE | |
